(19) United States
(12) Patent Application Publication
(10) Pub. No.: US 2025/0137506 A1
(43) Pub. Date: May 1, 2025

(54) Electromechanical Brake

(71) Applicant: Robert Bosch GmbH, Stuttgart (DE)

(72) Inventors: Xiaokun Zhang, Suzhou (CN); Fei Yu, Suzhou (CN)

(21) Appl. No.: 18/926,832

(22) Filed: Oct. 25, 2024

(30) Foreign Application Priority Data
Oct. 26, 2023 (CN) 2023 1140 3157.4

(51) Int. Cl. F16D 65/18; F16D 121/24; F16D 125/52; F16D 127/06

(52) U.S. Cl. CPC F16D 65/18; F16D 2121/24; F16D 2125/52; F16D 2127/06

(57) ABSTRACT

An electromechanical brake includes: a brake motor; a spindle coupled with the brake motor and rotating in a first direction under a drive of the brake motor to drive a brake caliper module to perform a brake operation; and a locking device having: an actuation member and a reset member, the actuation member causing the rotating lever to rotate from the idle position to the working position, and the reset member causing the rotating lever to return from the working position to the idle position. The operating ends of the ratchet and the rotating lever are set such that when in the working position, the operating end interacts with the ratchet to prevent the ratchet from rotating in a second direction opposite to the first direction and to prevent the rotating lever from rotating toward the idle position. The electromechanical brake according to the above configuration occupies a smaller space and is more compact.

This application claims priority under 35 U.S.C. § 119 to patent application no. CN 2023 1140 3157.4, filed on Oct. 26, 2023 in China, the disclosure of which is incorporated herein by reference in its entirety.

The present disclosure relates to the field of vehicle brake devices, and more specifically, to an electromechanical brake integrated with a locking device.

### BACKGROUND

An electromechanical brake is a device that utilizes an electric motor to actuate a brake caliper for braking. Compared to conventional hydraulic brake systems, it has advantages such as rapid response, simple structure, and ease of maintenance. With the development of vehicle electrification and intelligence, electromechanical brakes have become a development trend of braking systems thanks to their integrability with electric control systems. Because the electromechanical brake is disposed inside a vehicle hub, balancing the compactness and functionality is a challenge in the design of the electromechanical brake.

In a conventional hydraulic brake system, hydraulic pressure in a brake cylinder is maintained by a hand or a foot brake, thereby achieving parking brake. For the electromechanical brake, in order to achieve the parking brake function, a parking locking device is commonly configured, for example, a pin driven by an electromagnetic actuator is used to interfere with a transmission mechanism to lock the brake. However, such systems require the electromagnetic actuator to be powered on while parking a vehicle, and a failure of brake parking may be caused when the electromagnetic actuator breaks down.

### SUMMARY

An object of the present application is to solve or at least alleviate problems existing in the prior art.

According to one aspect of the present disclosure, an electromechanical brake is provided, comprising:
a brake motor;
a spindle coupled with the brake motor and a ratchet fixedly disposed on the spindle, the spindle defining an axial direction and rotating in a first direction under a drive of the brake motor to drive a brake caliper module to perform a brake operation; and
a locking device, comprising:
   a rotating lever comprising an operating end, the rotating lever being capable of rotating between an idle position, at which the operating end is separate from the ratchet, and a working position, at which the operating end is interlocked with the ratchet; and
   an actuation member and a reset member, the actuation member causing the rotating lever to rotate from the idle position to the working position, and the reset member causing the rotating lever to return from the working position to the idle position; wherein the ratchet and the operating end of the rotating lever are set such that when in the working position, the operating end interacts with the ratchet to prevent the ratchet from rotating in a second direction opposite to the first direction and to prevent the rotating lever from rotating towards the idle position.

Optionally, in an example of the electromechanical brake, the ratchet rotates with the spindle within a first plane perpendicular to the axial direction, the rotating lever being disposed to rotate in the first plane between the idle position and the working position; or the rotating lever being disposed to rotate within a second plane parallel to the first plane, the operating end of the rotating lever extending from the second plane to the first plane, the rotating lever being at least partially coincident with the ratchet in the axial direction.

Optionally, in an example of the electromechanical brake, the spindle includes a front end and a rear end opposing to each other, the front end of the spindle being coupled with the brake caliper module, and the ratchet being fixedly mounted to the rear end of the spindle.

Optionally, in an example of the electromechanical brake, a worm gear is fixedly disposed on a central section between the front end and the rear end of the spindle.

Optionally, in an example of the electromechanical brake, an output shaft of the brake motor intersects the axial direction and is configured as a worm meshed with the worm gear on the spindle.

Optionally, in an example of the electromechanical brake, the electromechanical brake comprises: a brake motor, a primary module, a brake caliper module, and an electronic control unit, the primary module including a primary housing and an end cap, a first end of the primary housing being connected to the brake caliper module, a second end of the primary housing opposite to the first end being sealed by the end cap.

Optionally, in an example of the electromechanical brake, the spindle, the ratchet, the worm gear, and the lock device are housed between the primary housing and the end cap.

Optionally, in an example of the electromechanical brake, the rotating lever and the reset member are pre-mounted to the end cap and assembled to the primary housing with the end cap.

Optionally, in an example of the electromechanical brake, the brake motor and the electronic control unit are connected to the primary housing from two opposing sides of the primary housing, the output shaft of the brake motor extends through the primary housing to the electronic control unit, and a position sensor is provided at an end of the output shaft of the brake motor, the electronic control unit being electrically connected with the brake motor and the actuation member of the locking device.

Optionally, in an example of the electromechanical brake, the actuation member is an electromagnet pre-mounted to the primary housing or the end cap, and the primary housing or the end cap has a port facing the electronic control unit for electrical coupling between the electromagnet and the electronic control unit, the reset member being a torsion spring disposed on a pivot axis of the rotating lever, or the reset member being a fold spring disposed between a plurality of positioning pins of the end cap.

Optionally, in an example of the electromechanical brake, the rotating lever has an axially extending working end, and the electromagnet acts on the working end.

Optionally, in an example of the electromechanical brake, a second force arm L2 from the operating end to a rotation center is 3 times or more, e.g., 5 times or more, a first force arm L1 from the working end to the rotation center.

Optionally, in an example of the electromechanical brake, the rotating lever also has a counterweight such that a centroid of the rotating lever is proximate the rotation center of the rotating lever.

Optionally, in an example of the electromechanical brake, the locking device further comprises a stop that provides a limit when the rotating lever is returned from the working position to the idle position.

Optionally, in an example of the electromechanical brake, the stop is a stop pin fixedly connected to the end cap.

Optionally, in an example of the said electromechanical brake, the stop pin is wrapped with a cushioning material.

Optionally, in an example of the electromechanical brake, the end cap has an additional cavity containing an electromagnet, and the electromagnet is disposed in the additional cavity.

Optionally, in an example of the electromechanical brake, the pivot axis of the rotating lever is disposed between bores corresponding to positions of the end cap and the primary housing, the rotating lever is rotatably fixed to the pivot axis, and the reset member is a torsion spring disposed on the pivot axis, a first end of the torsion spring abuts against the rotating lever, a second end of the torsion spring is fixed, and the rotating lever and the ratchet are in the same plane.

Optionally, in an example of the electromechanical brake, a second end of the primary housing has a cylindrical notch having an electromagnet cavity at a sidewall, the electromagnet cavity has a port in communication to the electronic control unit, the electromagnet being disposed in the electromagnet cavity such that a working end of the electromagnet faces the inside of the cylindrical notch, a connection port on a back side of the electromagnet facing the electronic control unit, and the end cap being disc-shaped and capable of being assembled to the cylindrical notch.

Optionally, in an example of the electromechanical brake, a pivot axis is provided on the end cap, and the rotating lever is rotatably fixed to the pivot axis.

Optionally, in an example of the electromechanical brake, the rotating lever includes a rotating lever body, the rotating lever body includes a pivot axis mounting aperture and a first arm, a second arm, and a third arm extending in three directions from the pivot axis mounting aperture, ends of the first arm, the second arm and the third arm respectively having an operating end, a working end, and a counterweight that extend axially, the rotating lever body being in a second plane parallel to the first plane, and the operating end, the working end and the counterweight extending axially from the second plane to the first plane, and during rotation of the rotating lever between the idle position and the working position, the working end and the counterweight being located radially outward of the ratchet.

Optionally, in an example of the electromechanical brake, the end cap also has a first positioning pin and a second positioning pin and a fold spring mounted on the first and second positioning pins.

Optionally, in an example of the electromechanical brake, the electromechanical brake further comprises an adapter connecting the electronic control unit, the electromagnet, and the brake motor, the adapter including an electromagnet bracket to support the electromagnet.

Optionally, in an example of the electromechanical brake, the pivot axis of the rotating lever includes a first post portion, a second post portion, and a transition portion, the first and second post portions being offset and connected by the transition portion, and the pivot axis being connected between the end cap and the offset mounting aperture of the primary housing.

The electromechanical brake according to examples of the present disclosure occupies a smaller space and is more compact.

### BRIEF DESCRIPTION OF THE DRAWINGS

With reference to the drawings, the content disclosed in the present application is to become understandable more easily. It will be readily understood by those skilled in the art that these drawings are for purposes of illustration only and are not intended to limit the scope of protection of the present application. Additionally, similar numerals in the drawings are used to represent similar components, wherein:

FIG. 1 shows an exploded view of an electromechanical brake when assembled to a hub according to an example;

FIG. 2 shows a stereoscopic view of an electromechanical brake according to a first example of the present disclosure;

FIG. 3 shows an exploded view of the electromechanical brake according to the first example of the present disclosure; and

FIG. 4 shows a schematic view of the electromechanical brake according to the first example of the present disclosure;

FIG. 5 shows an exploded view of an end cap and locking device according to the first example of the present disclosure;

FIG. 6 shows a stereoscopic view of a rotating lever according to the first example of the present disclosure;

FIG. 7 shows an assembled view of the end cap and the locking device according to the first example of the present disclosure;

FIG. 8 shows an exploded view of the locking device according to the first example of the present disclosure;

FIG. 9 shows a stereoscopic view of the electromechanical brake according to the first example of the present disclosure as the end cap is removed; FIGS. 10 and 11, respectively, show a front view and a stereoscopic view of the locking device in an idle state according to the first example of the present disclosure;

FIG. 12 shows a front view of the locking device according to the first example of the present disclosure during a transition from the idle state to a working state;

FIG. 13 shows a front view of the locking device in the working state according to the first example of the present disclosure; and FIG. 14 shows a partial design dimension of the locking device according to the first example of the present disclosure;

FIG. 15 shows a schematic diagram of assembling an end cap of the electromechanical brake according to the first example of the present disclosure; and FIG. 16 shows a schematic diagram of assembling an electronic control unit of the electromechanical brake according to the first example of the present disclosure;

FIG. 17 shows a stereoscopic view of an electromechanical brake according to a second example of the present disclosure;

FIG. 18 shows a partial exploded view of the electromechanical brake according to the second example of the present disclosure;

FIG. 19 shows a stereoscopic view of an end cap and a locking device of the electromechanical brake according to the second example of the present disclosure;

FIG. 20 shows an exploded view of the end cap and the locking device of the electromechanical brake according to the second example of the present disclosure;

FIG. 21 shows a stereoscopic view of a rotating lever according to the second example of the present disclosure;

FIGS. 22 and 23 respectively show a front view and a rear view of the locking device in an idle state according to the second example of the present disclosure;

FIGS. 24 and 25 respectively show a stereoscopic view and a front view of the locking device in the idle state according to the second example of the present disclosure;

FIG. 26 shows a schematic view of assembling the end cap of the electromechanical brake according to the second example of the present disclosure; FIG. 27 shows a schematic view of assembling the electromechanical brake according to the second example of the present disclosure; and FIG. 28 shows a stereoscopic view of an electromechanical brake according to a third example of the present disclosure;

FIG. 29 shows a partially exploded view of the electromechanical brake according to the third example of the present disclosure;

FIG. 30 shows a stereoscopic view of an end cap and a locking device of the electromechanical brake according to the third example of the present disclosure;

FIG. 31 shows a stereoscopic view of the locking device according to the third example of the present disclosure;

FIG. 32 shows an exploded view of the end cap and the locking device of the electromechanical brake according to the third example of the present disclosure;

FIG. 33 shows a stereoscopic view of a pivot pin according to the third example of the present disclosure;

FIGS. 34 and 35 respectively show a stereoscopic view of a primary housing according to the third example of the present disclosure and an enlarged view of a pivot pin receiving bore therein; and

FIG. 36 shows a stereoscopic view of an adapter of the electromechanical brake according to the third example of the present disclosure.

### DETAILED DESCRIPTION

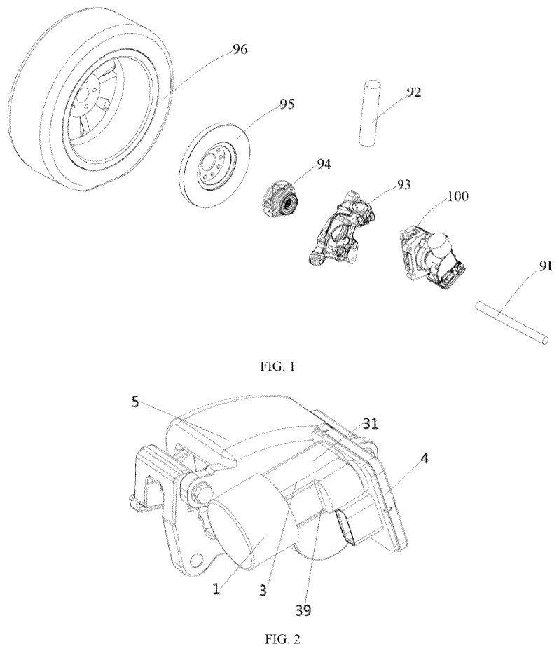

FIG. 1 shows a mounting diagram of an electromechanical brake, wherein a rotating shaft 91, a damper 92, a bearing 94, a steering knuckle arm 93, a brake disc 95, and a wheel 96, as well as an electromechanical brake 100 according to an example are shown, and the electromechanical brake is driven by an electric motor to provide a braking force by clamping the brake disc 95 with a brake caliper. When assembled, the electromechanical brake 100 is mounted on the steering knuckle arm 93, while the electromechanical brake 100 is housed within a compact space inside the hub of the wheel 96, thus having a strict limit on the volume of the electromechanical brake 100 itself.

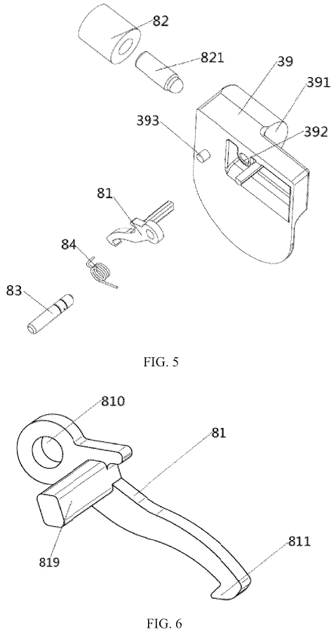

The electromechanical brake 100 according to the first example of the present disclosure is described with reference to FIGS. 2 to 16. The electromechanical brake 100 adopts a modular design and generally includes a brake motor 1, a primary module 3, a brake caliper module 5, and an electronic control unit 4. The primary module 3 houses a spindle 301 coupled with the brake motor 1, and a direction along which the spindle 301 is defined herein as an axial direction. The spindle 301 is driven by the brake motor 1 to rotate in a first direction to drive the brake caliper module 5 to perform a brake operation, i.e., be in friction with the brake disc 95, wherein a ratchet 33 is fixedly arranged on the spindle 301.

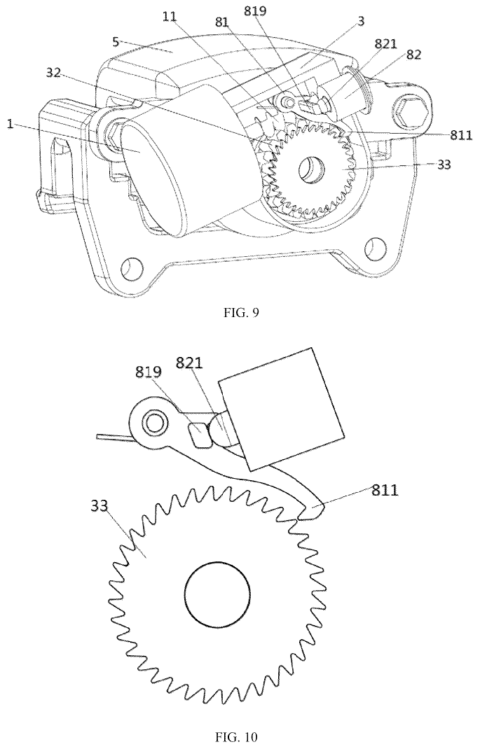

Referring to FIG. 4, the spindle 301 includes a front end 302 and a rear end 303. The front end 302 of the spindle 301, i.e., an end close to the brake caliper module 5, forms a lead screw of a ball screw nut mechanism 304, while the ratchet 33 is disposed at the rear end 303 of the spindle 301, i.e., an end far away from the brake caliper module 5. A central portion (position between the front end and the rear end) of the spindle 301 may be provided with a worm gear 32 to receive torque from the brake motor 1, and at least a portion of section of an output shaft 11 of the brake motor 1 may be configured as a worm, and the output shaft is oriented to intersect the axial direction and is meshed with the worm gear 32 to transmit the torque (see FIG. 9). The spindle 301 rotates in a first direction under the drive of the brake motor 1 and moves a plunger 305 by way of the ball screw nut mechanism 304 such that the brake caliper module 5 clamps the brake disc 95 to perform the brake function.

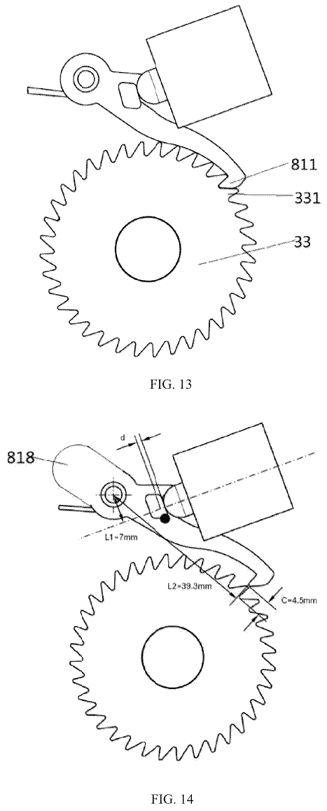

In another aspect, a locking device 8 is also provided to be matched with the ratchet 33 to achieve a parking brake function. The locking device comprises: a rotating lever 81, wherein the rotating lever 81 includes an operating end 811, the rotating lever is capable of rotating between an idle position in which the operating end 811 is separated from the ratchet (as shown in FIGS. 10 and 11), and a working position in which the operating end 811 is interlocked with the ratchet (as shown in FIG. 13); and an actuation member and a reset member, wherein the actuation member causes the rotating lever to rotate to the working position from the idle position, and the reset member causes the rotating lever to return to the idle position from the working position. Here, the ratchet and the operating end of the rotating lever are disposed such that the operating end 811 interferes with the ratchet 33 in the working position to prevent the ratchet 33 from rotating in a second direction opposite to the first direction and to prevent the rotating lever 81 from returning to the idle position.

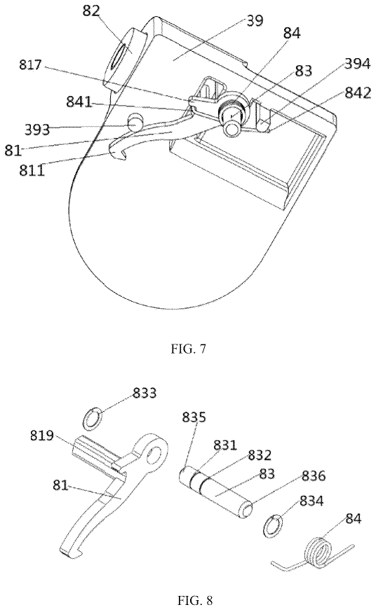

In some examples, the primary module 3 of the electromechanical brake includes a primary housing 31 and an end cap 39, wherein a first end of the primary housing 31 is connected to the brake caliper module 5, and a second end of the primary housing 31 that is opposite to the first end is enclosed by the end cap 39. The spindle 301, the ratchet 33, the worm gear 32 and the locking device 8, etc. are contained in space between the main housing 31 and the end cap 39. In a first example, the locking device 8 is disposed in the end cap 39. In particular, referring to FIG. 5, in some examples, the end cap 39 includes a body portion (lower portion) generally used to cover a ratchet position in the primary housing and an additional portion (upper portion) generally used to cover a worm position in the primary housing, the additional portion of the end cap having an additional cavity 391 that contains the actuation member of the locking device 8, and in the present example, the actuation member is an electrical magnet 82 and is disposed in the additional cavity 391 of the end cap. In the present example, the pivot axis 83 of the rotating lever 81 is connected between the bore 392 of the end cap and the bore (not shown) in the corresponding position of the primary housing, and the rotating lever 81 is rotatably fixed to the pivot axis 83, for example, the pivot axis 83 passes through the pivot axis mounting aperture 810 of the rotating lever 81. In the specific example shown in FIG. 8, the rotating lever 81 is positioned axially on the pivot axis 83 through slots 831,832 on the pivot axis 83 and corresponding clamping rings 833,834, while opposite ends 835,836 of the pivot axis 83 over-fit to the bores of the end cap 39 and the primary housing 31, respectively. In the present example, the reset member is a torsion spring 84 disposed on the pivot axis 83 and connected to the rotating lever 81. More specifically, referring to FIG. 7, a first end 841 of the torsion spring 84 abuts against a hook 817 of the rotating lever 81, the other end 842 of the torsion spring is fixed, for example, abuts against a first protrusion 394 on the end cap, and the torsion spring 84 is pre-compressed or pre-stretched, thereby providing a reset elastic force.

In addition, a second protrusion 393 is also provided on the end cap to limit the rotating lever 81 when the rotating lever is reset by the resilient member; and in some examples, the second protrusion 393 may be wrapped with a cushioning material to provide cushioning and reduce bump sound.

In some examples, the working end 819 of the rotating lever 81 extends axially, which is used to contact the actuation member, such as the working end 821 of the electromagnet 82, to receive power (visible in FIG. 8). In this first example, the rotating lever 81 is in the same plane as the ratchet 33, which is located approximately on one side of the ratchet that is close to the worm of the brake motor, and the rotating lever 81 receives rotation power by way of the working end 819 extending axially. Referring to FIGS. 10 to 13, the ratchet 33 rotates along with the spindle 301 within the first plane, the rotating lever 81 is disposed to rotate in the first plane, in the idle position, the rotating lever 81 is located on a radial outer side of the ratchet 33 (worm side), and ratches 331 of the ratchet 33 are located on a periphery of the ratchet 33. In some examples, the operating end 811 is configured as a hook, and in the working position, the book of the operating end 811 books one of the ratches 331 on the periphery of the ratchet, thereby achieving interlocking.

More specifically, FIG. 13 is taken as an example, where the counter-clockwise direction corresponds to the first direction in which the ratchet 33 rotates when receiving the drive of the brake motor 1, and when the brake motor 1 stops working, the ratchet 33 has a tendency to rotate in a second direction opposite to the first direction (clockwise direction in FIG. 13), and the ratches 331 will be locked with the hook of the operating end 811, thereby achieving interlocking. At the time, even if the electromagnet 82 is powered off, i.e., its working end 821 retracts, the ratches 331 and the operating end 811 will not be separated. Conversely, when the ratchet 33 is again rotated in the first direction (in the counter-clockwise direction in FIG. 13) under the action of the brake motor 1, the ratches 331 will direct the rotating lever 81 to rotate towards the idle position under the resetting elastic force of the torsion spring 84, thereby releasing both the rotating lever 81 and the ratchet 33.

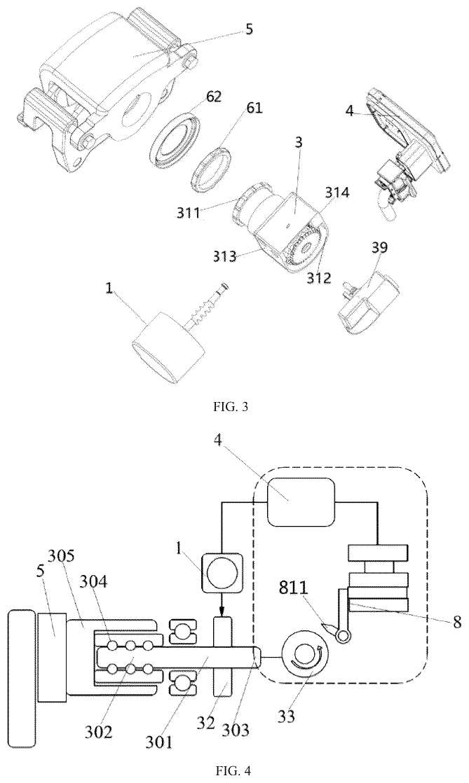

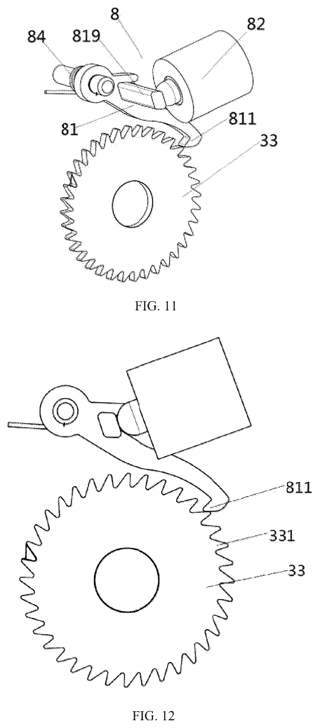

Referring to FIG. 3, the electromechanical brake according to the present disclosure adopts a modular design, and includes a primary module 3, and a brake caliper module 5 mounted at a distal end of the primary module 3, and a fastening nut 61 and a sealing ring 62 are provided therebetween. The primary module 3 includes a primary housing 31 and an end cap 39, and the primary housing 31 accommodates a spindle 301, a ball screw nut mechanism 304, a ratchet 33, a worm gear 32, and a locking device 8, etc. A first end 311 of the primary housing 31 is connected to the brake caliper module 5, and a second end 312 of the primary housing 31 that is opposite to the first end is enclosed by the end cap 39. The brake motor 1 and the electronic control unit 4 are integrated at opposing sides of the primary module 3, such as the first side 313 and the second side 314. It will be understood that operation of the brake motor 1 and the electromagnet 82 of the locking mechanism 8 is controlled by the electronic control unit 4. Specifically, as shown in FIG. 4, the brake motor 1 and the electromagnet 82 are connected to the electronic control unit 4. In parking brake control, upon receiving a parking brake signal, the electronic control unit 4 controls the brake motor 1 to rotate the spindle 301 in a first direction, thereby driving the brake caliper module 5 to establish a predetermined brake torque, even if the brake caliper clamps the brake disc 95. Subsequently, the electronic control unit 4 controls the electromagnet 82 to act on the rotating lever 81 to rotate from the idle position to the working position. At this time, the hook of the operating end of the rotating lever 81 is not necessarily aligned with the ratches 331 of the ratchet 33 (e.g., as shown in FIG. 12), and the brake motor 1 is controlled to slightly rotate (e.g., a position of one tooth) in the second direction to cause the operating end 811 of the rotating lever to move to the working position as shown in FIG. 13 to be interlocked with the ratches 331 of the ratchet 33. At this time, the electromagnet 82 and the brake motor 1 may be powered off. Since the rotating lever 81 is interlocked with the ratchet 33, the brake module 5 is still capable of retaining the brake torque even if the electromagnet 82 and the brake motor 1 are powered off. As a result, in a parking brake condition of a vehicle, the electromagnet 82 does not need to remain in operation, thereby reducing the risk of damage to the electromagnet 82 due to long-term operation. When the vehicle needs to be restarted, only the brake motor 1 needs to be controlled to rotate, then the ratchet 33 will rotate in the first direction, and the rotating lever 81 will return to the idle position under the guidance of the ratches of the ratchet 33 and under the action of the reset member until the next parking brake.

With continued reference to FIG. 14, in some examples, a maximum engagement depth c of the ratches 331 of the ratchet 33 and the rotating lever 81 is greater than 3 mm, e.g., the maximum engagement depth c of the ratches 331 of the ratchet 33 is 4.5 mm to ensure stability when the two are interlocked. Further, a second force arm L2 from the operating end of the rotating lever 81 to a rotation center is 3 times or more a first force arm L1 from the working end to the rotation center. For example, in the example shown in the drawings, the second force arm L2 is 39.3 mm, the first force arm L1 is 7 mm, and the second force arm L2 is 5 times or more the first force arm L1, and such setting may reduce a displacement d of the electromagnet 82. L1 On the other hand, the rotating lever 81 may have a counterweight 818, such that the center of gravity of the rotating lever is closer to the rotation center, which may reduce the requirement for the capability of the electromagnet 82, i.e., the electromagnet 82 may have a smaller thrust and therefore have a smaller volume.

With continued reference to FIGS. 15 and 16, the end cap 39 to which the locking device 8 is mounted in advance is assembled to the primary housing 31, and a first sealing piece 318 is disposed between the primary housing 31 and the end cap 39 to provide a seal therebetween. Subsequently, the electronic control unit 4 is assembled to the primary module 3, and the end cap 39 has a port for the connection between the electromagnet 82 and the electronic control unit 4, and a second sealing piece 82 is provided around the port. The primary housing 31 also has a port facing the electronic control unit, wherein the output shaft 11 of the brake motor is exposed, and a position sensor may be provided thereon, whereby the angular position of the output shaft is monitored by the electronic control unit 4. Additional bore 310 may be used, for example, to arrange a line for connecting the brake motor 1 and the electronic control unit 4. A third sealing piece 319 surrounds the output shaft 11 of the brake motor 1 and the bore 310 to provide an additional seal. It can be seen from the above structure that the electromechanical brake according to the first example of the present disclosure is compact in structure, reasonably arranged, convenient to assemble, and the modular design is convenient for subsequent maintenance.

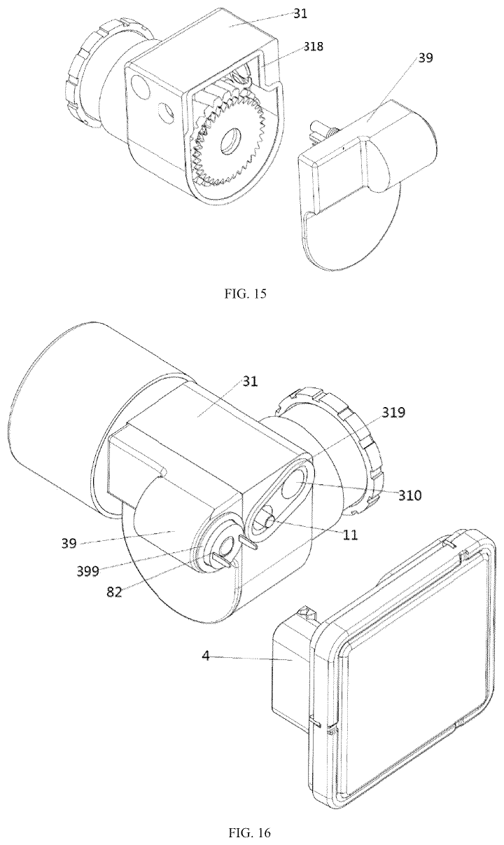

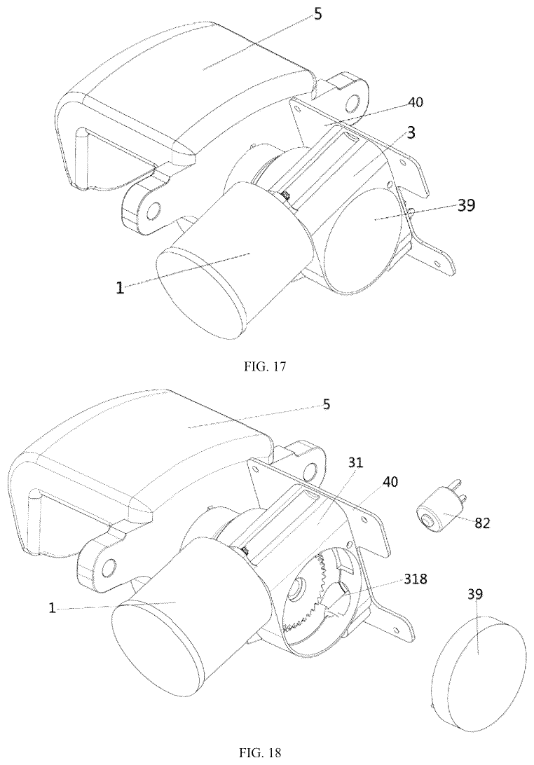

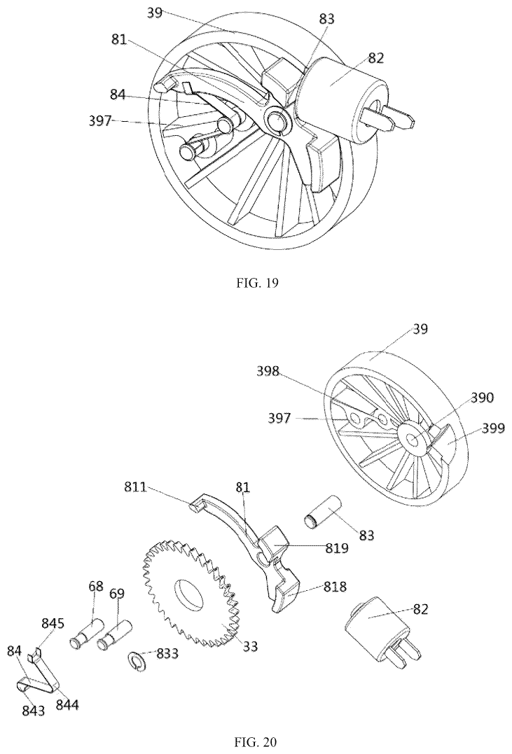

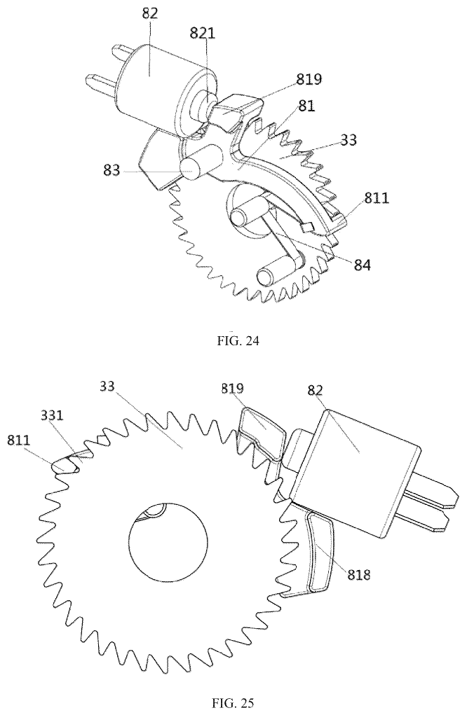

The second example of the present disclosure will be described with continued reference to FIGS. 17 to 27. In the second example, only a back plate 40 of the electronic control unit is used in place of the electronic control unit 4, and other identical components are indicated by the same reference numerals. In this example, the second end of the primary housing 31 of the primary module 3 has a cylindrical notch, and the end cap 39 is also disposed in a generally disc shape. In this example, the locking device 8 is also substantially integrated in the end cap 39, with the actuation member, i.e., the electromagnet 82, provided at the primary housing 31. Specifically, an electromagnet cavity 318 is provided at a sidewall of the cylindrical notch, and the electromagnet 82 is housed in the electromagnet cavity 318. The end cap 39 also has a wall 399 (FIG. 20) that matches the cylindrical profile of the electromagnet 82 such that the electromagnet 82 is positioned between and in contact with the primary housing 31 and the end cap 39 when in place. With reference to FIG. 19, when the electromagnet 82 is mounted in place, its working end 821 faces the rotating lever 81, and the connection port on a back side of the electromagnet 82 faces the electronic control unit 4.

With continued reference to FIG. 20, it can be seen that the inner side of the end cap 39 has a shaft bore 390 for arranging the pivot axis 83 of the rotating lever, and bores 397,398 for arranging the first positioning pin 68 and the second positioning pin 69, and furthermore, the inner side of the end cap 39 also has a plurality of stiffeners that diverge from the shaft bore 390. One end of the pivot axis 83 is matched to the shaft bore 390 and passes through the pivot axis mounting aperture 810 of the rotating lever 81 to be positioned axially by the clamping ring 833. The fold spring 84 is mounted on the first positioning pin 68 and the second positioning pin 69. Specifically, a first end 843 of the fold spring 84 is fixed to the first positioning pin 68, a bending part 844 of which bypasses the second positioning pin 69, and a second end 845 abuts against the rotating lever, and the second end 845 is formed, for example, as a slot or a collar to better support an arm of the rotating lever that is connected to the operating end 811.

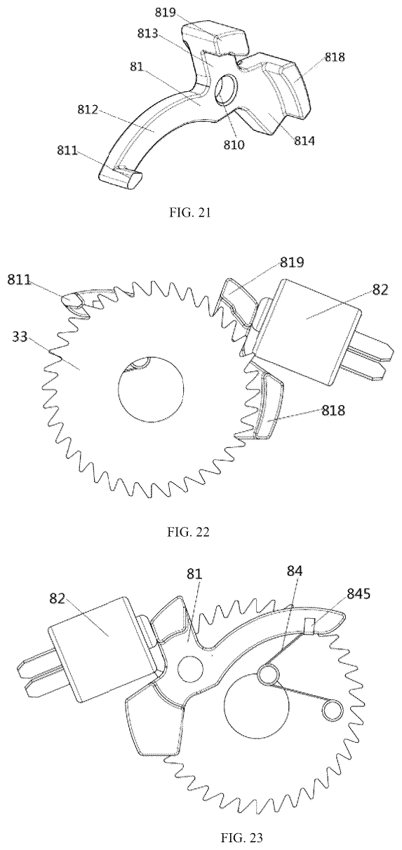

With continued reference to FIG. 21, a specific structure of the rotating lever 81 is shown. The rotating lever 81 includes a first arm 812, a second arm 813, and a third arm 814 that extend from the pivot axis mounting aperture 810 in three directions, and ends of the first arm 812, the second arm 813, and the third arm 814 extend axially to have an operating end 811, a working end 819 and a counterweight 818, respectively. The operating end 811 is used to interact with the ratchet 33 in a manner detailed above in conjunction with the first example, the working end 819 receives a pulling force of the electromagnet 82, and the counterweight 818 is configured such that the center of gravity of the rotating lever is close to a pivot center. As can be seen from FIGS. 21 to 25, with the rotation plane of the ratchet 33 being a first plane, the rotating lever 81 rotates within a second plane parallel to the first plane, and the second plane is further away from the brake caliper module 5.

In some examples, the rotating lever 81 is at least partially coincident in the axial direction with the ratchet 33, with its operating end 811, working end 819 and counterweight 818 extending axially from the second plane to the first plane and located radially outward of the ratchet, respectively. More specifically, the working end 819 and the counterweight 818 are always located radially outward of the ratchet 33 during rotation of the rotating lever between the idle position and the working position, while the manner of interaction between the operating end 811 and the ratches of the ratchet is substantially the same as that described in the first example, which is not repeated here. Through this arrangement, the locking device 8 may only add a small amount of size to the primary module 1 in the axial direction without adding size in other directions, making the primary module 1 more compact.

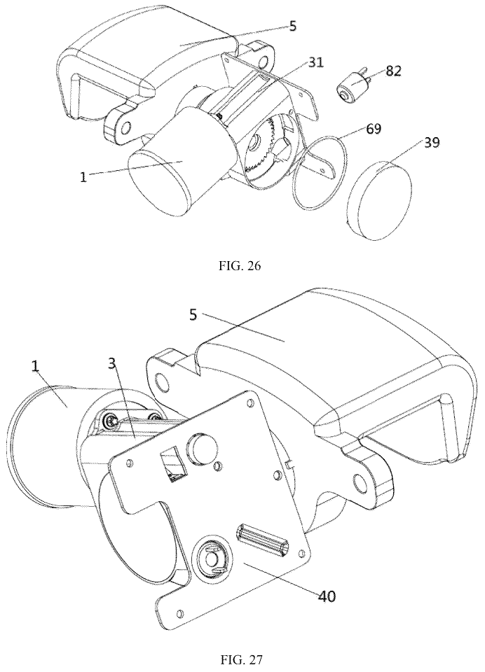

With continued reference to FIGS. 26 and 27, the end cap 39 is disc shaped and is capable of being assembled into the cylindrical notch of the primary housing 31, while the sealing piece 69 is provided between the two. Similarly, the connection port of the electromagnet 82 and the end of the motor output shaft extend to the electronic control unit 4.

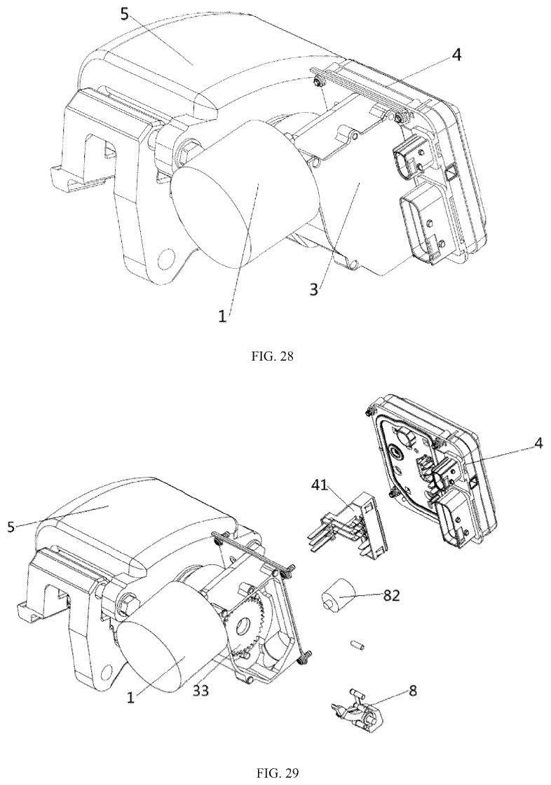

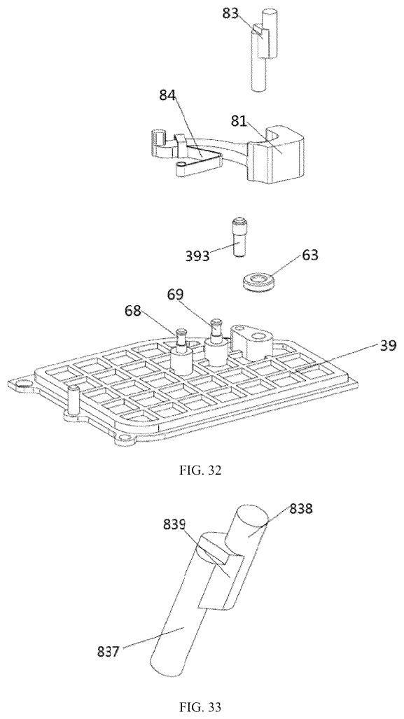

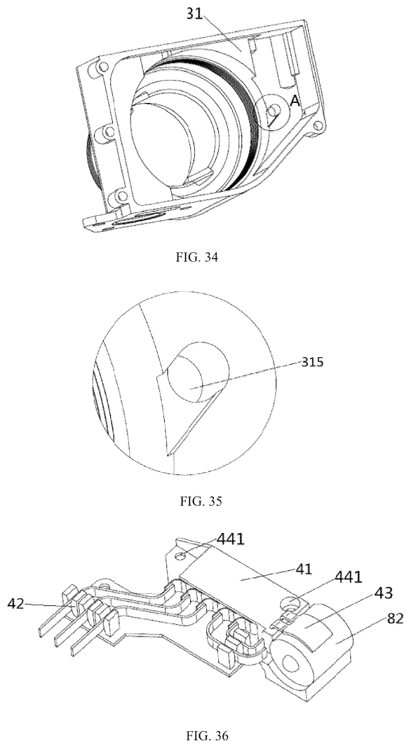

A third example according to the present disclosure is continued to be introduced with reference to FIGS. 28 to 36. In this example, an adaptor 41 is provided between the electronic control unit 4 and the electromagnet 82 and the brake motor 1, and in some examples, the adapter 41 may include a clamping portion 43 that receives the electromagnet 82, as shown in FIG. 36. The adapter 41 also includes a plurality of positioning mounting holes 441.

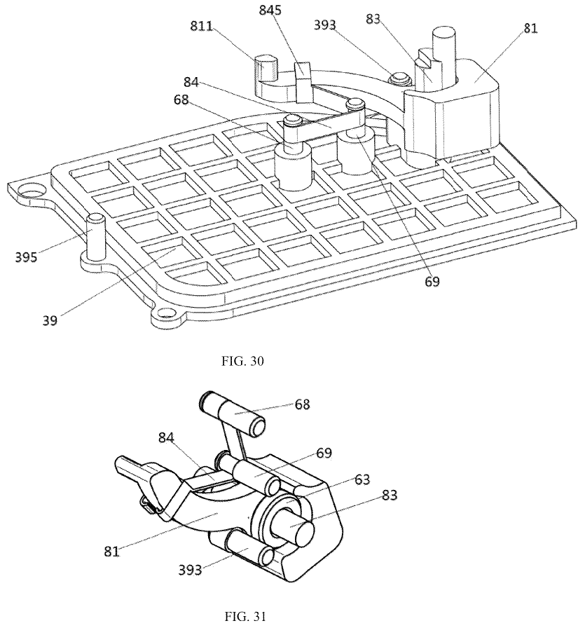

Referring to FIGS. 30 and 31, a locking device in combination with the end cap 39 and a separate locking device are shown. In some examples, the end cap 39 is designed with at least one positioning post 395 inserted into the mounting hole of the primary housing for bearing a counter force to which the end cap is subjected when the ratchet is interlocked with the rotating lever. Additionally, in this third example, the reset member is similar to the fold spring employed by the second example, and the pivot axis 83 is configured with a first post portion 837, a second post portion 838, and a transition portion 839 due to the inability to open a bore at a corresponding position at the primary housing, and the first post portion 837 and the second post portion 838 are biased and are connected by the transition portion 839. The first post portion 837 is inserted through the bore on the end cap by passing through a positioning pad 63, the second post portion 838 is inserted into a positioning hole 315 of the primary housing 31, and the positioning hole 315 is disposed to accommodate both the second post portion 838 and the transition portion 839, thereby inhibiting rotation of the pivot axis 83. The pivot axis 83 passes through the rotating lever 81, and the operating end 811 of the rotating lever 81 interacts with the ratchet 33 in a manner detailed above in conjunction with the first example.

The specific examples described above in the present application are intended to only describe the principles of the present application more clearly, i.e. clearly illustrate or describe various components to make the principles of the present disclosure easier to understand. Within the scope of the present application, those skilled in the art can easily make various modifications or changes to the present application. Therefore, it should be understood that these modifications or changes are all comprised within the scope of the patent protection of the present application.

What is claimed is:

1. An electromechanical brake, comprising:
a brake motor;
a spindle coupled with the brake motor and a ratchet fixedly disposed on the spindle, the spindle defining an axial direction and rotating in a first direction under a drive of the brake motor to drive a brake caliper module to perform a brake operation; and
a locking device, comprising:
a rotating lever comprising an operating end, the rotating lever being configured to rotate between an idle position, at which the operating end is separate from the ratchet, and a working position, at which the operating end is interlocked with the ratchet; and
an actuation member and a reset member, the actuation member causing the rotating lever to rotate from the idle position to the working position, and the reset member causing the rotating lever to return to the idle position from the working position,
wherein the ratchet and the operating end of the rotating lever are disposed such that when in the working position, the operating end interacts with the ratchet to prevent the ratchet from rotating in a second direction opposite to the first direction and to prevent the rotating lever from rotating towards the idle position.

2. The electromechanical brake according to claim 1, wherein:
the ratchet rotates with the spindle within a first plane perpendicular to the axial direction, the rotating lever being disposed to rotate between the idle position and the working position in the first plane; or
the rotating lever is disposed to rotate within a second plane parallel to the first plane, the operating end of the rotating lever extending from the second plane to the first plane, the rotating lever being at least partially coincident with the ratchet in the axial direction.

3. The electromechanical brake according to claim 1, wherein the spindle includes a front end and a rear end opposing to each other, the front end of the spindle is coupled with the brake caliper module, the ratchet is fixedly mounted to the rear end of the spindle.

4. The electromechanical brake according to claim 1, wherein the electromechanical brake comprises: a brake motor, a primary module, a brake caliper module, and an electronic control unit, the primary module including a primary housing and an end cap, a first end of the primary housing connected to the brake caliper module, a second end of the primary housing opposite to the first end being sealed by the end cap.

5. The electromechanical brake according to claim 4, wherein the actuation member is an electromagnet, the electromagnet is pre-mounted to the primary housing or the end cap, and the primary housing or the end cap has a port facing the electronic control unit for electrical coupling between the electromagnet and the electronic control unit, the reset member being a torsion spring arranged on a pivot axis of the rotating lever, or the reset member being a fold spring arranged between a plurality of positioning pins of the end cap.

6. The electromechanical brake according to claim 5, wherein the rotating lever has a working end that extends in the axial direction, and the electromagnet acts on the working end, wherein a second force arm from the operating end to a rotation center is 3 times or more a first force arm from the working end to the rotation center, wherein the rotating lever also has a counterweight such that a centroid of the rotating lever is close to the rotation center of the rotating lever.

7. The electromechanical brake according to claim 5, wherein the locking device further comprises a stop, the stop providing a limit when the rotating lever is returned from the working position to the idle position, and wherein the stop is a stop pin fixedly connected to the end cap.

8. The electromechanical brake according to claim 4, wherein the end cap has an additional cavity containing an electromagnet, the electromagnet is disposed in the additional cavity, wherein a pivot axis of the rotating lever is disposed between bores corresponding to positions of the end cap and the primary housing, the rotating lever is rotatably fixed to the pivot axis, and the reset member is a torsion spring arranged on the pivot axis, a first end of the torsion spring abuts against the rotating lever, a second end of the torsion spring is fixed, and the rotating lever and the ratchet are in the same plane.

9. The electromechanical brake according to claim 4, wherein a second end of the primary housing has a cylindrical notch, the cylindrical notch has an electromagnet cavity at a sidewall, the electromagnet cavity has a port in communication to the electronic control unit, the electromagnet is disposed in the electromagnet cavity such that a working end of the electromagnet faces the inside of the cylindrical notch, a connection port on a back side of the electromagnet faces the electronic control unit, and the end cap is disc-shaped and is configured to be assembled to the cylindrical notch, wherein a pivot axis is provided on the end cap, the rotating lever is rotatably fixed to the pivot axis, wherein the rotating lever includes a rotating lever body, the rotating lever body including a pivot axis mounting aperture and a first arm, a second arm, and a third arm extending from the pivot axis mounting aperture in three directions, ends of the first arm, the second arm and the third arm respectively having an operating end, a working end, and a counterweight that extend axially, the rotating lever body is in a second plane parallel to the first plane, and the operating end, the working end and the counterweight extend axially from the second plane to the first plane, during rotation of the rotating lever between the idle position and the working position, the working end and the counterweight are located radially outward of the ratchet, wherein the end cap also has a first positioning pin and a second positioning pin and a fold spring mounted on the first and second positioning pins.

10. The electromechanical brake according to claim 4, wherein the electromechanical brake further comprises an adapter connecting the electronic control unit, the electromagnet and the brake motor, the adapter including an electromagnet clamping portion to receive the electromagnet, wherein the pivot axis of the rotating lever includes a first post portion, a second post portion, and a transition portion, the first post portion and the second post portion are offset and connected by the transition portion, and the pivot axis is connected between the end cap and the offset mounting aperture of the primary housing.

11. The electromechanical brake according to claim 3, wherein a worm gear is fixedly disposed on a central section between the front end and the rear end of the spindle, and wherein an output shaft of the brake motor intersects the axial direction and is configured as a worm meshed with the worm gear on the spindle.

12. The electromechanical brake according to claim 4, wherein:
the spindle, the ratchet, the worm gear, and the locking device are received between the primary housing and the end cap,
the rotating lever and the reset member are pre-mounted to the end cap and assembled to the primary housing with the end cap, and
the brake motor and the electronic control unit are coupled to the primary housing from two opposing sides of the primary housing, the output shaft of the brake motor extends through the primary housing to the electronic control unit, and a position sensor is provided at an end of the output shaft of the brake motor, the electronic control unit being electrically connected with the brake motor and the actuation member of the locking device.

13. The electromechanical brake according to claim 5, wherein the rotating lever has a working end that extends in the axial direction, and the electromagnet acts on the working end, wherein a second force arm from the operating end to a rotation center is 5 times or more a first force arm from the working end to the rotation center, and wherein the rotating lever also has a counterweight such that a centroid of the rotating lever is close to the rotation center of the rotating lever.

14. The electromechanical brake according to claim 7, wherein the stop pin is wrapped with a cushioning material.
